(19) United States
(12) Patent Application Publication
(10) Pub. No.: US 2026/0060271 A1
(43) Pub. Date: Mar. 5, 2026

(54) COLD DRINK MACHINE AND FREEZING CYLINDER STRUCTURE THEREOF

(71) Applicant: Guangzhou Xin'an Trading Co., Ltd., Guangzhou (CN)

(72) Inventor: Quan Zhou, Guangzhou (CN)

(21) Appl. No.: 19/079,536

(22) Filed: Mar. 14, 2025

(30) Foreign Application Priority Data
Aug. 29, 2024 (CN) 202422120703.X
Sep. 5, 2024 (CN) 202422184878.7

(51) Int. Cl. A23G 9/22; A23G 9/28

(52) U.S. Cl. CPC A23G 9/222; A23G 9/224; A23G 9/281

(57) ABSTRACT

A cold drink machine and its freezing cylinder structure, the freezing cylinder structure comprises: an ice storage container and a refrigeration mechanism; the ice storage shell is provided with an ice storage chamber; the refrigeration end of the refrigeration mechanism is attached to the outer side wall of the ice storage chamber and extends from the end of the ice storage chamber away from the opening to the middle of the ice storage chamber, forming a melting gap between the refrigeration end and the opening of the ice storage chamber. This solution enables the formation of a melting gap between the refrigeration end and the opening of the ice storage chamber, creating two regions with different temperatures within the ice storage chamber, thus solving the problem of insufficient ice flow due to the single temperature maintained in the refrigeration zone of conventional cold drink machines.

### CROSS REFERENCE TO RELATED APPLICATIONS

The present application claims the benefit of Chinese Patent Application Nos. 2024221848787 filed on Sep. 5, 2024 and 202422120703X filed on Aug. 29, 2024, the contents of which are incorporated herein by reference in their entirety.

### TECHNICAL FIELD

The application relates to the field of cold drink, particularly to a cold drink machine and its freezing cylinder structure.

### BACKGROUND ART

The existing cold drink machines utilize a storage container to store icy materials and employ refrigeration equipment to cool or maintain the temperature of the storage container. However, when the storage container needs to dispense materials, the temperature of the materials being dispensed is close to the storage temperature, meaning there is a small temperature difference between the storage area and the dispensing area. This results in insufficient fluidity of the materials in the dispensing area, making it difficult for the materials to be directly dispensed from the storage area through the dispensing area without assistance from external forces. Especially after prolonged use, the materials in the storage and dispensing areas are prone to forming large, solid blocks, which may obstruct the dispensing path of the materials, thereby affecting the dispensing process and reducing the dispensing efficiency.

### SUMMARY

The objective of the present application is to propose a freezing cylinder structure for a cold drink machine, wherein the cooling end of the refrigeration mechanism is arranged on the outer side wall of the ice storage chamber and extends from the end of the ice storage chamber to the middle, creating a melting gap between the cooling end and the opening of the ice storage chamber. This design allows the ice storage chamber to be divided into two regions with different temperatures, ensuring both ice-making capacity and improved material flow at the opening of the ice storage chamber.

The present application also proposes a cold drink machine that utilizes the aforementioned freezing cylinder structure for a cold drink machine.

To achieve this objective, the following technical solution is adopted.

A freezing cylinder structure for a cold drink machine is provided, which comprises: an ice storage container and a refrigeration mechanism.

The ice storage container comprises: an ice storage shell.

The ice storage shell is provided with an ice storage chamber, which has an opening exposed at one horizontal end of the ice storage shell; the cooling end of the refrigeration mechanism is attached to the outer side wall of the ice storage chamber and extends from the end of the ice storage chamber away from the opening to the middle of the ice storage chamber, forming a melting gap between the cooling end and the opening of the ice storage chamber.

Optionally, the cooling end of the refrigeration mechanism is provided with a refrigeration tube, which is distributed around the outer side wall of the ice storage chamber and extends from the end of the ice storage chamber away from the opening to the middle of the ice storage chamber.

Optionally, it further comprises a spiral stirring paddle.

The spiral stirring paddle is rotatably mounted in the ice storage chamber; the spiral stirring paddle is used to convey materials towards the opening of the ice storage chamber.

Optionally, it further comprises an agitator driver.

The ice storage shell is provided with an integrally combined shell cylinder at the end away from the opening of the ice storage chamber; the shell cylinder is connected to the ice storage chamber; the fixed end of the agitator driver is connected to the shell cylinder, and the output end of the agitator driver is connected to the spiral stirring paddle to drive the spiral stirring paddle to rotate.

Optionally, it Further Comprises a Padding Plate.

The padding plate has padding openings exposed around the shell cylinder, with multiple padding openings respectively engaged with different shell cylinders; the padding plate is attached to the outer side wall of the ice storage shell, and the agitator driver is detachably fixed to the padding plate.

Optionally, the padding plate is provided with plate screw holes; the fixed end of the agitator driver is screwed into the plate screw holes, allowing the agitator driver to be detachably mounted on the padding plate.

Optionally, it further comprises a feeding device.

The feeding device is detachably fixed to the padding plate, and the output end of the feeding device extends into one of the shell cylinders.

Optionally, the ice storage container further comprises an ice discharge cover.

The ice discharge cover is mounted on the ice storage shell.

The ice discharge cover is provided with an ice discharge chamber, which is horizontally connected to the ice storage chamber; the ice discharge chamber is used to receive materials from the ice storage chamber and is provided with an ice discharge opening.

The wall thickness of the ice discharge cover in the ice discharge chamber is greater than the wall thickness of the ice storage shell in the ice storage chamber.

Optionally, the ice discharge opening is located on the bottom wall of the ice discharge chamber and away from the opening of the ice discharge chamber; the side walls of the ice discharge chamber gradually move away from the center of the ice discharge chamber from the bottom wall to the opening, causing the side walls of the ice discharge chamber to extend inclinedly towards the opening of the ice storage chamber.

A cold drink machine provided with the aforementioned freezing cylinder structure for a cold drink machine.

Compared with the prior art, one of the technical solutions mentioned above has the following beneficial effects.

The present solution provides a freezing cylinder structure for a cold drink machine, wherein the cooling end of the refrigeration mechanism is arranged on the outer side wall of the ice storage chamber and extends from the end to the middle of the ice storage chamber, creating a melting gap between the cooling end and the opening of the ice storage chamber. This design allows the ice storage chamber to be divided into two regions with different temperatures, ensuring both ice-making capacity and improved material flow at the opening of the ice storage chamber, thus solving the problem of insufficient flow during ice discharge caused by maintaining a single temperature in the refrigeration zone of conventional cold drink machines.

### BRIEF DESCRIPTION OF THE DRAWINGS

FIG. 1 is an exploded view of one embodiment of the ice cream freezer cylinder structure;

FIG. 2 is an exploded view of one embodiment showing the connection between the gasket plate and the ice storage shell;

FIG. 3 is a sectional view of one embodiment of the ice cream freezer cylinder structure;

FIG. 4 is an enlarged view of part A in FIG. 3;

FIG. 5 is a partial sectional view of one embodiment of the ice discharge chamber.

### REFERENCE NUMBERS

1—Ice storage container; 2—Refrigeration mechanism; 4—Spiral agitator; 5—Agitator driver; 6—Gasket plate; 7—Feeding device; 11—Ice storage shell; 12—Ice discharge cover; 111—Ice storage chamber; 121—Ice discharge chamber; 122—Ice discharge port; 21—Refrigeration tube; 16—Shell cylinder; 61—Gasket opening; 62—Plate screw hole.

### DETAILED DESCRIPTION

Below is a detailed description of the embodiments of the present application, with examples of said embodiments shown in the accompanying drawings. Throughout, the same or similar reference numerals denote the same or similar components or components with the same or similar functions. The embodiments described with reference to the accompanying drawings are exemplary and are intended solely for explaining the present application, and are not to be construed as limiting the present application.

In the description of the present application, it should be understood that terms such as “center”, “longitudinal”, “transverse”, “length”, “width”, “thickness”, “upper”, “lower”, “left”, “right”, “front”, “rear”, “vertical”, “horizontal”, “top”, “bottom”, “inner”, “outer”, “inner side”, “outer side”, “inner end”, “outer end”, “axial”, “radial”, “circumferential”, etc., indicate orientations or positional relationships based on the orientations or positions shown in the drawings. They are used only for the convenience of describing the present application and simplifying the description, and do not indicate or imply that the device or component referred to must have a specific orientation, be constructed or operated in a specific orientation, and therefore cannot be construed as limiting the present application. In addition, features designated as “first”, “second”, etc., may explicitly or implicitly comprise one or more of such features, used to distinguish between described features, without any order or priority implied. In the description of the present application, unless otherwise specified, the term “plurality” means more than two.

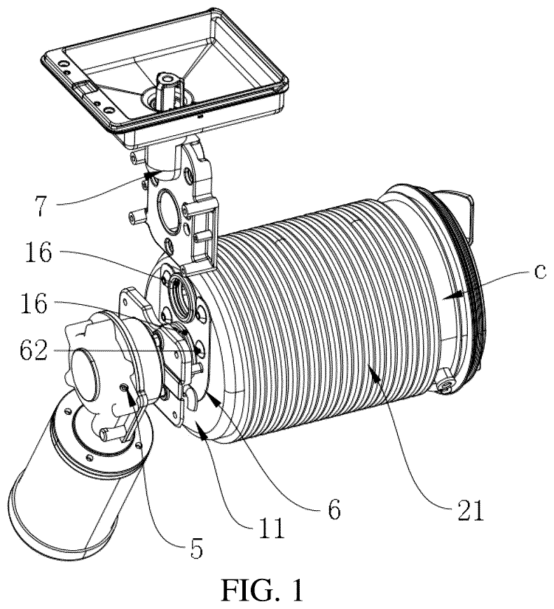

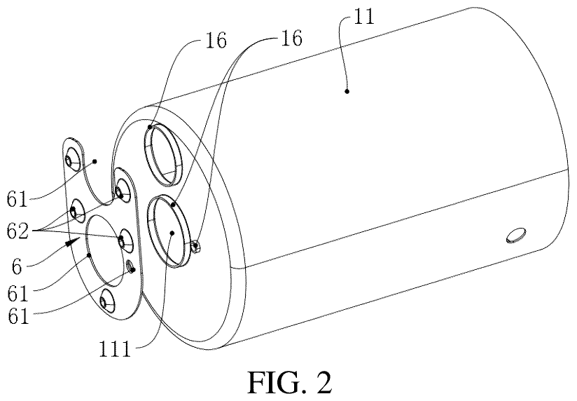

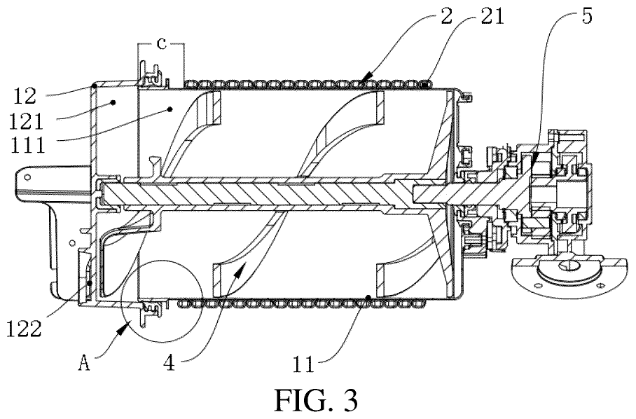

As shown in FIGS. 1-5, an ice cream freezer cylinder structure for a cold beverage machine comprises an ice storage container 1 and a refrigeration mechanism 2.

The ice storage container 1 comprises an ice storage shell 11.

The ice storage shell 11 is provided with an ice storage chamber 111, with an opening exposed at one horizontal end of the ice storage shell 11; the refrigerating end of the refrigeration mechanism 2 is attached to the outer side wall of the ice storage chamber 111 and extends from the end of the ice storage chamber 111 away from the opening to the middle of the ice storage chamber 111, forming a melting gap c between the refrigerating end and the opening of the ice storage chamber 111.

The present solution provides an ice cream freezer cylinder structure for a cold beverage machine, wherein the refrigerating end of the refrigeration mechanism 2 is arranged on the outer side wall of the ice storage chamber 111 and extends from the end of the ice storage chamber to its middle, forming a melting gap c between the refrigerating end and the opening of the ice storage chamber 111. This allows the ice storage chamber 111 to be divided into two regions with different temperatures, ensuring ice-making capacity while improving the fluidity at the opening of the ice storage chamber 111, thus solving the problem of insufficient fluidity during ice discharge in conventional cold beverage machines where the refrigeration zone maintains a single temperature.

Specifically, the ice storage shell 11 is provided with an ice storage chamber 111, with an opening exposed at one horizontal end of the ice storage shell 11 for discharging or transferring refrigerated materials from the ice storage shell 11. The outer side wall of the ice storage shell 11 is provided with the refrigerating end of the refrigeration mechanism 2, which has a refrigeration function to reduce the temperature of the outer side wall of the ice storage chamber 111, thereby keeping the interior of the ice storage chamber 111 at a low temperature suitable for material storage. Since the refrigerating end of the refrigeration mechanism 2 extends from the end of the ice storage chamber 111 away from the opening to the middle of the ice storage chamber 111 (here, “middle of the ice storage chamber 111” does not refer to the absolute middle but any position between the opening at one horizontal end and the other horizontal end of the ice storage chamber 111), the portion of the ice storage chamber 111 in contact with the refrigerating end of the refrigeration mechanism 2 can maintain the storage temperature of the materials, keeping them in a solid (ice) state with low fluidity. The melting gap c formed between the refrigerating end and the opening of the ice storage chamber 111 allows the outer side wall of the ice storage chamber 111 in the melting gap c to be in contact with air, which heats this portion of the outer side wall, raising the temperature in the melting gap c. As a result, the materials in the melting gap c partially melt, increasing the fluidity of the materials in the ice storage chamber 111 and thus the speed at which they are discharged from the opening of the ice storage chamber 111, preventing material residue at the opening. This solution addresses the problem of insufficient fluidity during ice discharge due to the single temperature maintained in the refrigeration zone of conventional cold beverage machines.

Optionally, the refrigerating end of the refrigeration mechanism 2 is provided with a refrigeration tube 21, which is annularly distributed on the outer side wall of the ice storage chamber 111 and extends from the end of the ice storage chamber 111 away from the opening to the middle of the ice storage chamber 111.

The refrigerating end of the refrigeration mechanism 2 in this solution can be provided with a refrigeration tube 21 through which a refrigerant medium can be circulated to remove heat from the ice storage chamber 111, thereby maintaining it at a low temperature. Since the refrigeration tube 21 is annularly distributed on the outer side wall of the ice storage chamber 111, it effectively clings to the outer side wall, providing optimal refrigeration for the ice storage chamber 111. The region of the ice storage chamber 111 in the melting gap c, devoid of the refrigeration tube 21, primarily comes into contact with air, resulting in a significant temperature difference between the melting gap c and the non-melting gap regions, enhancing the melting effect.

Optionally, the structure further comprises: a spiral agitator 4.

The spiral agitator 4 is rotatably disposed in the ice storage chamber 111 and is used to convey materials toward the opening of the ice storage chamber 111.

The spiral agitator 4 is rotatably mounted in the ice storage container 1 and is driven by a known mechanism with rotational drive functionality, such as a motor or a combination of a motor and a reducer. When the spiral agitator 4 rotates, it drives the materials in the ice storage chamber 111 to be output through the opening into an ice discharge chamber 121. The spiral agitator 4 serves to mix the materials, preventing them from being stored in blocks and dispersing the ice-like materials in the ice storage container 1 into granular form. It also ensures uniform mixing of different ice-like materials (the ice storage container 1 can be used to store different types of materials).

Optionally, the structure further comprises: an agitator driver 5.

The ice storage shell 11 is provided with an integrally formed shell cylinder 16 at the end away from the opening of the ice storage chamber 111; the shell cylinder 16 is connected to the ice storage chamber 111; the fixed end of the agitator driver 5 is connected to the shell cylinder 16, and the output end of the agitator driver 5 is connected to the spiral agitator 4 to drive the spiral agitator 4 to rotate.

To achieve automatic material mixing, an agitator driver 5 is typically added to the ice cream freezer cylinder structure. However, there is no direct connection point between the agitator driver 5 and the ice storage shell, necessitating the addition of a shell cylinder 16. In this solution, it is preferable to provide the ice storage shell 11 with a shell cylinder 16 at the end away from the opening, with the shell cylinder 16 being integrally formed with the ice storage shell 11, i.e., there is no connection gap between the shell cylinder 16 and the ice storage shell 11, preventing material residue in the connection gap between the agitator driver 5 and the shell cylinder 16 under the action of agitation, thereby improving the cleanliness of the ice cream freezer cylinder structure.

Optionally, the structure further comprises: a gasket plate 6.

The gasket plate 6 has gasket openings 61 exposed around the periphery of the shell cylinder 16, with multiple gasket openings 61 respectively engaged with different shell cylinders 16; the gasket plate 6 is attached to the outer side wall of the ice storage shell 11, and the agitator driver 5 is detachably fixed to the gasket plate 6.

A pad 6 is placed between the agitator driver 5 and the ice storage shell 11 to prevent direct contact between the two. At the same time, since there are multiple pad openings 61 on the pad 6, when at least two pad openings 61 are respectively engaged with two shell cylinders 16, the angle of the pad 6 can be locked. In this solution, the pad 6 is attached to the ice storage shell 11, either by welding, gluing, or other means, so that the pad 6 can replace the side of the ice storage shell 11 to connect with the agitator driver 5, providing a fixed position for the agitator driver 5, while also preventing the agitator driver 5 from being directly fixed to the ice storage shell 11. This eliminates the need to drill screw holes on the surface of the ice storage shell 11 to connect with the agitator driver 5, thus preventing material residue in the screw holes.

Optionally, the pad 6 is provided with plate screw holes 62; screws on the fixed end of the agitator driver 5 mate with the plate screw holes 62, allowing the agitator driver 5 to be detachably mounted on the pad 6.

This solution allows the pad 6 to replace the outer side wall of the ice storage shell 11 to provide plate screw holes 62, which can be used to mate with screws. When it is necessary to install the agitator driver 5, screws can be passed through the fixed end of the agitator driver 5 and mated with the plate screw holes 62, thereby simplifying the installation and removal process of the agitator driver 5 and avoiding the issue of material residue that would occur if screw holes were directly provided on the ice storage shell 11.

Optionally, the Device Further Comprises: a Feeding Device 7.

The feeding device 7 is detachably fixed to the pad 6, and the output end of the feeding device 7 extends into one of the shell cylinders 16.

Some of the shell cylinders 16 can serve as the inlet for the ice storage shell 11. Specifically, the output end of the feeding device 7 is extended into the shell cylinder 16, directly outputting the material from the feeding device 7 into the ice storage chamber 111. Since the output position of the feeding device 7 is located at the contact point of a cooling end of the refrigeration mechanism 2, the material can be cooled immediately after being input. Similarly, the feeding device 7 can also use screws to mate with the plate screw holes 62.

Optionally, the ice storage container 1 further comprises an ice discharge cover 12;

The ice discharge cover 12 is mounted on the ice storage shell 11.

The ice discharge cover 12 is provided with an ice dispensing chamber 121, which is horizontally connected to the ice storage chamber 111. The ice dispensing chamber 121 is used to receive the material from the ice storage chamber 111, and is provided with an ice dispensing opening 122.

The wall thickness a of the ice discharge cover 12 in the ice dispensing chamber 121 is greater than the wall thickness b of the ice storage shell 11 in the ice storage chamber 111.

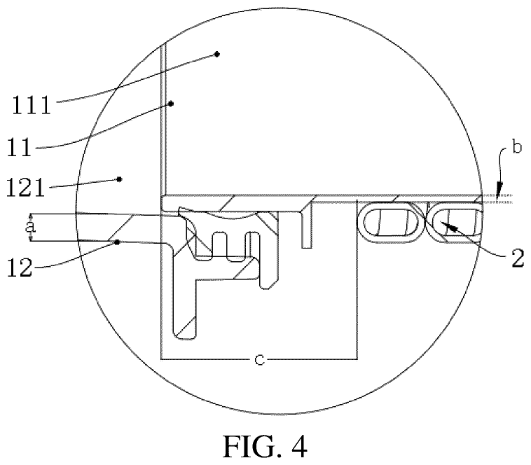

Specifically, the ice storage container 1 of this solution comprises an ice storage shell 11 and an ice discharge cover 12; the ice storage shell 11 and the ice discharge cover 12 can be integrally formed or detachably connected into one unit. The ice storage shell 11 is provided with an ice storage chamber 111, which is equivalent to the main ice storage area of a conventional ice dispenser. The outer side wall of the ice storage shell 11 is provided with the cooling end of a refrigeration mechanism 2, which has a cooling function to reduce the temperature of the outer side wall of the ice storage chamber 111, thereby keeping the interior of the ice storage chamber 111 at a low temperature to meet the storage temperature requirements of the material. The ice discharge cover 12 is provided with an ice dispensing chamber 121 and an ice dispensing opening 122 in the ice dispensing chamber 121. The ice dispensing chamber 121 can be used to receive the material from the ice storage chamber 111 and output the material to the outside through the ice dispensing opening 122, thereby completing the ice dispensing process. In this solution, wall thickness refers to the spacing between the outer side wall and the inner side wall. In this solution, as shown in FIG. 4, the wall thickness a of the ice dispensing chamber 121 is greater than the wall thickness b of the ice storage chamber 111. The wall thickness b of the ice storage chamber 111 is smaller, and the cooling end of the refrigeration mechanism 2 is attached to the outer side wall of the ice storage chamber 111. The cooling effect of the refrigeration mechanism 2 on the ice storage chamber 111 is improved. However, the outer side of the ice dispensing chamber 121 does not have a refrigeration mechanism 2; it mainly comes into contact with air or other structures. Air surrounds the outer side wall of the ice dispensing chamber 121, and thus the air will heat the interior of the ice dispensing chamber 121 through its outer side wall, causing the temperature of the ice dispensing chamber 121 to rise slightly. The ingenious aspect of this solution lies in designing the wall thickness a of the ice dispensing chamber 121 to be greater than the wall thickness b of the ice storage chamber 111. Although the air will cause the temperature of the ice dispensing chamber 121 to increase, the greater the wall thickness of the ice dispensing chamber 121, the better the thermal insulation effect, resulting in a smaller temperature change rate per unit time. Therefore, the temperature of the material will decrease when passing through the ice dispensing chamber 121, but it will only be slightly lower than the temperature of the ice storage chamber 111. That is, the temperature will not drop sharply in the ice dispensing chamber 121. Obviously, the material has a better cooling effect in the ice storage chamber 111, and the temperature of the ice dispensing chamber 121 will decrease when it enters the ice dispensing chamber 121, but the decrease will not be too significant. Therefore, this solution can control the wall thickness a of the ice dispensing chamber 121 to make the temperature of the material slightly lower than its freezing point, allowing a small portion of the material to melt, resulting in a solid-liquid coexistence state, which increases the fluidity of the material. This makes it easier for the material to be discharged from the ice dispensing opening 122 when it has a certain fluidity, reducing the amount of material residue at the ice dispensing opening 122 and avoiding the situation where the temperature of the ice dispenser is too low, causing insufficient fluidity during ice dispensing, leading to residue and blockage at the ice dispensing opening 122, as well as avoiding the situation where the temperature during ice dispensing is too high, causing a decrease in ice dispensing volume and residue at the ice dispensing opening 122.

Optionally, the ice dispensing opening 122 is provided on the bottom wall of the ice dispensing chamber 121 and is located away from the opening of the ice dispensing chamber 121; the side wall of the ice dispensing chamber 121 gradually moves away from the center of the ice dispensing chamber 121 from the bottom wall to the opening, so that the side wall of the ice dispensing chamber 121 extends inclined towards the opening of the ice storage chamber 111.

The side wall of the ice dispensing chamber 121 in this solution can be a straight side wall with zero inclination.

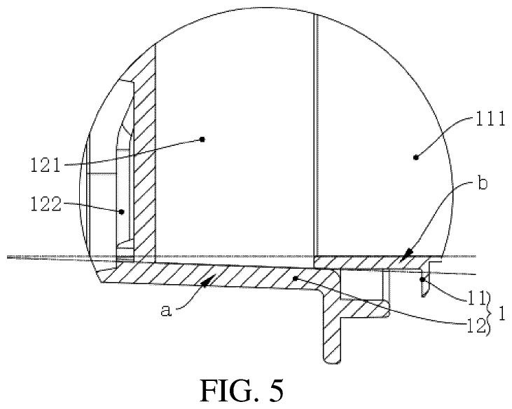

As shown in FIG. 5, in the optimal embodiment, the side walls of the ice dispensing chamber 121 have a certain inclination angle. Specifically, one horizontal end of the ice dispensing chamber 121 is an opening, and the other horizontal end is a bottom wall. The ice outlet 122 is provided on the bottom wall of the ice dispensing chamber 121, that is, the ice outlet 122 is horizontally away from the opening of the ice dispensing chamber 121. When the opening of the ice dispensing chamber 121 receives material from the ice storage chamber 111, the material needs to move along the side walls of the ice dispensing chamber 121 before being dispensed to the ice outlet 122. The side walls of the ice dispensing chamber 121 gradually move away from the center of the ice dispensing chamber 121 from the bottom wall to the opening, that is, the side walls of the ice dispensing chamber 121 are farthest from the center of the ice dispensing chamber 121 near the opening and closest to the center at the bottom wall. Thus, the side walls of the ice dispensing chamber 121 extend obliquely. As shown in FIG. 5, the side walls of the ice dispensing chamber 121 extend obliquely upward from the opening of the ice storage chamber 111 toward the ice outlet 122. With this structure, the material will first be dispensed obliquely upward along the side walls of the ice dispensing chamber 121 during dispensing. The side walls of the ice dispensing chamber 121 can slow down the movement of the material, thereby extending the dwell time of the material on the side walls of the ice dispensing chamber 121, allowing partial melting of the material before it is dispensed to the ice outlet 122. When the ice dispensing structure completes dispensing, the material has dwelled on the side walls of the ice dispensing chamber 121 for a sufficient amount of time, resulting in longer melting time, more liquid portion, and ability to flow back downward along the side walls of the ice dispensing chamber 121, thus speeding up the return of the material to the ice storage chamber 111 and allowing the material to return to the ice storage chamber 111. Therefore, this solution cleverly utilizes the inclination angle of the side walls of the ice dispensing chamber 121 to improve the efficiency of dispensing and material return.

A cold drink machine is provided with a freezing cylinder structure of a cold drink machine according to any of the above-mentioned embodiments.

Although embodiments of the present invention have been shown and described, it will be understood by those skilled in the art that various changes, modifications, substitutions, and alterations can be made to these embodiments without departing from the principles and spirit of the present invention. The scope of the present invention is defined by the claims and their equivalents.

What is claimed is:

1. A freezing cylinder structure for a cold drink machine, comprising: an ice storage container and a refrigeration mechanism;
the ice storage container comprises: an ice storage shell;
the ice storage shell is provided with an ice storage chamber, which has an opening exposed at one horizontal end of the ice storage shell; the refrigeration end of the refrigeration mechanism is attached to the outer side wall of the ice storage chamber and extends from the end of the ice storage chamber away from the opening to the middle of the ice storage chamber, forming a melting gap between the refrigeration end and the opening of the ice storage chamber.

2. The freezing cylinder structure for a cold drink machine according to claim 1, wherein the refrigeration end of the refrigeration mechanism is provided with a refrigeration tube, which is distributed around the outer side wall of the ice storage chamber and extends from the end of the ice storage chamber away from the opening to the middle of the ice storage chamber in a circular manner.

3. The freezing cylinder structure for a cold drink machine according to claim 1, further comprising: a spiral stirring paddle;
the spiral stirring paddle is rotatably disposed in the ice storage chamber; the spiral stirring paddle is used to convey materials towards the opening of the ice storage chamber.

4. The freezing cylinder structure for a cold drink machine according to claim 3, further comprising: an agitator driver;
the ice storage shell is provided with an integrally combined shell cylinder at the end away from the opening of the ice storage chamber; the shell cylinder is connected to the ice storage chamber; the fixed end of the agitator driver is connected to the shell cylinder, and the output end of the agitator driver is connected to the spiral stirring paddle to drive the spiral stirring paddle to rotate.

5. The freezing cylinder structure for a cold drink machine according to claim 4, further comprising: a gasket plate;
the gasket plate has gasket openings exposed around the periphery of the shell cylinder, with multiple gasket openings respectively engaged with different shell cylinders; the gasket plate is attached to the outer side wall of the ice storage shell, and the agitator driver is detachably fixed to the gasket plate.

6. The freezing cylinder structure for a cold drink machine according to claim 5, wherein the gasket plate is provided with plate screw holes; the fixed end of the agitator driver is screwed into the plate screw holes, allowing the agitator driver to be detachably installed on the gasket plate.

7. The freezing cylinder structure for a cold drink machine according to claim 5, further comprising: a feeding device;
the feeding device is detachably fixed to the gasket plate, and the output end of the feeding device extends into one of the shell cylinders.

8. The freezing cylinder structure for a cold drink machine according to claim 1, wherein the ice storage container further comprises: an ice discharge cover;
the ice discharge cover is mounted on the ice storage shell;
the ice discharge cover is provided with an ice dispensing chamber, which is horizontally connected to the ice storage chamber; the ice dispensing chamber is used to receive materials from the ice storage chamber and is provided with an ice dispensing opening;
the wall thickness of the ice discharge cover in the ice dispensing chamber is greater than the wall thickness of the ice storage shell in the ice storage chamber.

9. The freezing cylinder structure for a cold drink machine according to claim 8, wherein the ice dispensing opening is provided on the bottom wall of the ice dispensing chamber and is located away from the opening of the ice dispensing chamber; the side wall of the ice dispensing chamber gradually moves away from the center of the ice dispensing chamber from the bottom wall to the opening, causing the side wall of the ice dispensing chamber to extend inclinedly towards the opening of the ice storage chamber.

10. A cold drink machine, wherein it is provided with the freezing cylinder structure for a cold drink machine according to claim 1.
